(19) United States
(12) Patent Application Publication
(10) Pub. No.: US 2004/0120686 A1
(43) Pub. Date: Jun. 24, 2004

(54) Optical waveguide

(76) Inventors: Hans-Josef Behrens, Dormagen (DE); Ebert Wolfgang, Krefeld (DE); Thomas Follinger, Dormagen (DE); Wolfgang Alewelt, Krefeld (DE); Heniz-Dieter Brandt, Willich (DE); Martina Brandt, Willich (DE); Franziska Hanne Brandt, Willich (DE); Inken Margarethe Brandt, Willich (DE)

Correspondence Address: Bayer Polymers, Patent Department, 100 Bayer Road, Pittsburgh, PA, 15205-9741, US

(21) Appl. No.: 10/415,870

(22) PCT Filed: Oct. 24, 2001
(86) PCT No.: PCT/EP01/12261

(30) Foreign Application Priority Data
Nov. 6, 2000 (DE) 100 54 935.7

(51) Int. Cl. G02B 6/00

(52) U.S. Cl. 385/143

(57) ABSTRACT

A process for producing optical fibers is disclosed. The fibers that are characterized in having a core that contain an amorphous transparent thermoplastic polymer are prepared by a process entailing melting the polymer in an apparatus the surfaces of which that come into contact with the molten polymer are first rendered at least partially inert.

The present invention relates to a process for producing a light guide containing a core containing an amorphous, transparent, thermoplastic polymer, wherein the polymer is processed in the melt and wherein the surfaces of the apparatus used in this process are rendered fully or partly inert at points where they come into contact with the molten polymer.

Light guides are used to transfer optical signals. Light guides contain a core made of optically transparent material. The core may consist, for example, of glass or a plastics material. The core is also called a fibre. The core or the fibre may have any cross-section and diameter at all. In practice, the cross-section and diameter are chosen in accordance with the present technical requirements.

The core of the light guide is usually coated. The coating may consist, for example, of a plastics material or a lacquer. The coating provides a certain degree of protection against mechanical effects on the core. Furthermore, the coating improves the efficiency of transfer of optical signals by the light guide. Thus, the mechanical and optical properties of the coating in particular are important.

This system of core and coating may be surrounded by a sleeve or a casing. This is used, for example, to protect against damage and effects of the environment.

Transfer of the optical signal, preferably by visible light, takes place in light guides primarily in the core. Thus the optical properties of the core in particular are important.

Light guides made of polymers are known, e.g. from A. Weinert, “Kunststoff-Lichtwellenleiter”, Pulicis-MCD Verlag, 1998.

Light guides based on plastics coated polycarbonate fibres are also known from:

(a) EP-A 0 203 327;

(b) JP-A 84/216 104;

(c) JP-A 84/216 105;

(d) JP-A 84/218 404;

(e) JP-A 86/231 510;

(f) JP-A 86/240 206;

(g) JP-A 86/245 110;

(h) JP-A 86/278 807.

In these documents, light guides based on polycarbonate fibres are described in which the polycarbonate cores are coated with specific fluorine-containing polymers ((a), (e), (f), (h)), with specific mixed polymers of methyl methacrylates, styrene or vinyltoluene and maleic anhydride (b), with specific mixed polymers of methyl methacrylates, α-methylstyrene and maleic anhydride (c), with specific mixed polymers of methyl methacrylate, α-methylstyrene, styrene and maleic anhydride (d) and with silicone resins, silicone/acrylate resins, urethane/acrylate resins, polyamides or poly-4-methylpentene-1 (g).

EP-A 0 327 807 discloses light guides with a core of polycarbonate and a coating of polymerised acrylates and/or methacrylates.

A conventional process for producing light guides is to draw out a fibre from a so-called preform, such as is practised in the case of light guides made of glass.

This is a batchwise process which is suitable when defect-free preforms are obtainable, e.g. by bulk polymerisation of polymers.

In the case of thermoplastic polycondensates, for which defect-free preforms are very difficult to obtain, due to the volatile constituents which have to be removed from the melt during the build up in molecular weight and also due to shrinkage of the cooling melt, the production of a light-guiding fibre by means of extrusion is a suitable process.

Essential properties for a polymeric light guide are good transparency, which depends on the purity and absorption spectrum of the initial polymer, its thermal resistance, which is based on the building blocks making up the polymer, and its mechanical strength, which is determined substantially by the molecular weight of the initial polymer and the conditions of production of the light-guiding fibre.

Due to the beneficial materials properties of in principle readily processable and highly economically viable thermoplastic polymers, it is beneficial to provide light guides made from these materials. The disadvantage is that the known processes in the prior art for producing light guides from thermoplastic polymers are frequently not suitable for producing light guides of high quality, in particular of high optical quality.

The object of the present invention thus comprises providing a process for producing light guides with good optical properties.

This object is achieved by a process for producing a light guide containing a core containing an amorphous, transparent, thermoplastic polymer, wherein the polymer is processed in the melt and wherein the surfaces of the apparatus used in this process are rendered fully or partly inert at points where they come into contact with the molten polymer.

The surfaces at points where they come into contact with the polymer melt are preferably rendered fully inert.

Furthermore, the polymer melt is preferably extruded.

A process in which the surfaces are rendered inert in that the surfaces consist of materials which contain less than 70 wt. % of metallic iron is preferred.

Furthermore, a process in which the surfaces are rendered inert in that the surfaces consist of a nitride layer, particularly preferably iron nitride, is preferred.

The material mentioned is preferably chosen from the group consisting of ceramic materials, chromium/nickel alloys and stainless steel with an iron content of less than 70 wt. %.

Materials with less than 10 wt. % of metallic iron at the surface are very particularly preferred, such as e.g.

Alloy 59 (2.4605)

Inconell 686 (2.4606)

Alloy B-2

Alloy B-3

Alloy B-4

Hastelloy C-32

Hastelloy C-276

Hastelloy C-4

tantalum

and steel surfaces completely coated with an iron nitride layer.

Another embodiment comprises, instead of making the corresponding parts from the preferred and particularly preferred materials, plating unsuitable steels with the preferred and particularly preferred materials.

Light guides with a polycarbonate core according to the invention are preferred.

Light guides according to the invention preferably contain a core of polycarbonate and a coating containing a polymer which contains repeating units derived from the monomers

A) one or more different compounds of the formula (1)

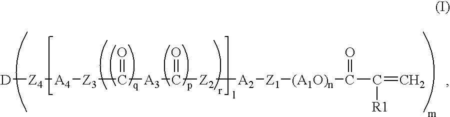

in which

m represents 2, 3 or 4,

D represents the m-valent group from an aliphatic or aromatic hydrocarbon,

R₁ is hydrogen or methyl,

Z₁, Z₂ and Z₃, independently, represent oxygen, sulfur, the —N(R) group (in which R is hydrogen or unsubstituted or substituted, preferably unsubstituted, alkyl, aralkyl or aryl) or a divalent group of the formula (II)

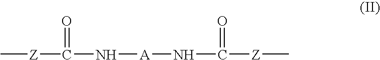

in which

Z represents oxygen, sulfur or the —N(R) group, and

A represents an unsubstituted or substituted, preferably unsubstituted, divalent group from an aliphatic, cycloaliphatic, araliphatic or aromatic hydrocarbon,

Z₄ represents oxygen, the divalent group of the formula (II) or one of the following divalent groups

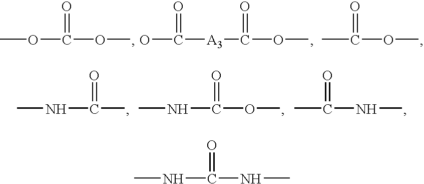

A₁, A₂, A₃ and A₄, independently, represent an unsubstituted or substituted, preferably unsubstituted, divalent group from an aliphatic, cycloaliphatic, aromatic-aliphatic or aromatic hydrocarbon,

n is zero or an integer from 1 to 20,

p, q and r, independently, may take on the value zero or 1 and

I has a numerical value such that the weight average of the molecular weight of the compound of the formula (I) is 450 to 5000, and

B) one or more different compounds of the formula (III)

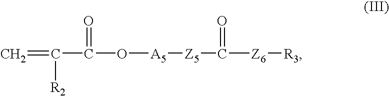

in which

R₂ is hydrogen or methyl,

A₅ represents an unsubstituted or substituted, preferably unsubstituted, divalent group from an aliphatic or cycloaliphatic hydrocarbon,

Z₅ and Z₆, independently, represent oxygen, sulfur or the —N(R′) groups, in which R′ is hydrogen or unsubstituted or substituted, preferably unsubstituted alkyl, aralkyl or aryl, and

R₃ represents an unsubstituted or substituted, preferably unsubstituted, alkyl, cycloalkyl or aralkyl group,

wherein in a particularly preferred embodiment the coating contains one or more different stabilisers chosen from the group consisting of organic phosphites and organic sulfides.

The said light guides are particularly preferably those in which A₁, A₂, A₃, A₄ and A, independently, represent an unsubstituted or substituted, preferably unsubstituted, divalent aliphatic or cycloaliphatic hydrocarbon group.

Furthermore, the said light guides are particularly preferably those in which p and q have the value 1,

Z₂ and Z₃ represent oxygen,

Z₁ represents oxygen or the group

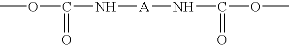

in which A is an unsubstituted or substituted, preferably unsubstituted, divalent group from an aliphatic or cycloaliphatic C₂-C₁₈ hydrocarbon, preferably the group

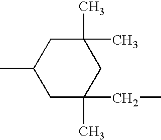

Z₄ represents oxygen or the group

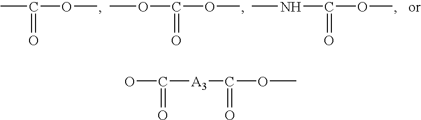

in which A₃ is an unsubstituted or substituted, preferably unsubstituted, C₂-C₁₈ group from an aliphatic or cycloaliphatic hydrocarbon,

A₁ is an ethylene or propylene-1,2 group and

A₂, A₃ and A₄, independently, are unsubstituted or substituted, preferably unsubstituted, divalent groups, preferably C₂-C₈ groups, from aliphatic or cycloaliphatic hydrocarbons.

Furthermore, the said light guides are particularly preferably those in which, in formula (III)

A₅ is an unsubstituted or substituted, preferably unsubstituted, C₂-C₆ alkylene group,

Z₅ and Z₆, independently, represent oxygen or the —NH group and

R₃ is a C₁-C₁₈ alkyl group.

Furthermore, the said light guides are particularly preferably those in which, in formula (III)

R₃ represents an unsubstituted or substituted, preferably unsubstituted, C₁-C₅ alkyl group,

A₅ represents an ethylene group and

Z₅ represents oxygen and Z₆ represents the —NH group.

The said stabilisers are compounds which offer protection against thermooxidative ageing of the coating or act as radical traps.

The said stabilisers are chosen from the group consisting of organic phosphites and organic sulfides.

It is preferred that the concentration of stabilisers in the coating is 0.01 wt. % to 0.5 wt. %.

It is preferred that, in the said coated light guides, the proportion of repeating units derived from the monomers mentioned under A) in the polymer is 25 to 75 wt. % and the proportion of repeating units derived from the monomers mentioned under B) in the polymer is 25 to 75 wt. % and wherein the sum of the proportions of repeating units derived from the monomers mentioned under A) and under B) in the polymer is 50 to 100 wt. %, particularly preferably 100 wt. %.

In a preferred embodiment, the process for producing light guides according to the invention comprises coating the core of the light guide with a composition containing the monomers A) and B) and optionally the stabilisers and one or more different photoinitiators, wherein the composition is polymerised on the core by UV irradiation.

A process in which the proportion of photoinitiators in the composition is 0.1 to 10 wt. % is preferred.

Light guides according to the invention may be used in means of transport.

The preferred coating according to the invention contains one or more different stabilisers, preferably at a concentration of 0.01 wt. % to 0.5 wt. %, particularly preferably 0.05 wt. % to 0.3 wt. %.

According to the invention, compounds suitable for use as stabilisers are chosen from the group consisting of organic phosphites and organic sulfides. Organic sulfides with sterically hindered phenolic groups are very particularly preferred.

Furthermore, stabilisers which contain 3-[3′,5′-bis-(1″,1″-dimethylethyl)-4′-hydroxyphenyl]propionic acid or structures derived therefrom as a structural element are preferred.

The process according to the invention has a number of advantages. The advantageous properties of polymer fibres, as mentioned above, are not impaired. They are perhaps even amplified by the coating according to the invention in light guides according to the invention. The optical, mechanical and thermal properties of light guides according to the invention, are very good.

The rate of hardening of preferred coatings according to the invention is very high, which enables an advantageous production process.

Preferred coatings according to the invention ensure that there is no stress crack formation in the polycarbonate fibre.

The use of light guides according to the invention in means of transport is advantageous because light guides according to the invention enable a weight reduction as compared with known light guides, for example those made of glass. In addition, they have advantageous mechanical properties, in particular light guides according to the invention are unbreakable when compared with light guides made of glass. In addition, light guides according to the invention are much simpler to handle and enable better connection techniques.

The advantageous properties of light guides with polycarbonate cores are in particular high transparency, high refractive index, high thermal resistance, good mechanical properties such as e.g. high flexural strength and high tear strength and also a low capacity for absorbing water.

Copper cables are conventionally used for signal transfers in cars, in comparison with which a considerable weight reduction is possible.

Means of transport in the context of the present invention are in particular cars, track vehicles, ships and aircraft.

Stabilisers according to the invention are known or can be prepared by known processes. Some of them are commercially available. They can be obtained, for example, from Ciba Spezialitaten GmbH, Lampertheim, Germany.

The monomers for coatings according to the invention are known or can be prepared by known processes. Some are commercially available.

Examples of D, as a tetravalent group from aliphatic or aromatic hydrocarbons, which may be mentioned are for example the parent hydrocarbon groups from tetravalent aliphatic alcohols such as e.g. pentaerythritol.

Examples of D, as a trivalent group from aliphatic or aromatic hydrocarbons, which may be mentioned are for example the parent hydrocarbon groups from aliphatic triols such as glycerine, trimethylolethane, trimethylolpropane or hexanetriol, aromatic tricarboxylic acids such as benzene-1,2,4 tricarboxylic acid or benzene-1,3,5 tricarboxylic acid or aromatic triisocyanates such as 2,4,6-toluylene triisocyanate or 4,4′,4″-triphenylmethane triisocyanate.

Examples of D, A₁, A₂, A₃, A₄ and A₅ as optionally substituted divalent groups from aliphatic, cycloaliphatic, araliphatic or aromatic hydrocarbons which may be mentioned are the parent hydrocarbon groups from in particular aliphatic diols such as ethylene glycol, 1,2-propanediol, 1,3-propanediol, 2,2-dimethyl-1,3-propanediol, 1,2-butanediol, 1,3-butanediol, 2,3-butanediol, 1,4-butanediol, 1,5-pentanediol, 1,6- and 2,5-hexanediol, diethylene glycol, triethylene glycol, dipropylene glycol, 2,2,4-trimethylpentanediol-1,3,2-methylpentanediol-2,4 and 2-ethylhexanediol-1,3 or cycloaliphatic diols such as 2,2-dimethyl-4,4-dimethyl-cyclobutanediol, 1,2-cyclopentanediol, 1,3-cyclopentanediol, 1,2-, 1,3- and 1,4-cyclohexanediol, 1,4-bishydroxymethylcyclohexane, 2,2-bis-(4-hydroxycyclohexyl)-propane, 1-methyl-2,2-bis-(4-hydroxycyclohexyl)-ethane, 2-methyl-2,4-bis-(4-hydroxycyclohexyl)-pentane and bis-hydroxymethyl-hexahydro-4,7-methanoindane.

For A₃, in addition, the parent hydrocarbon groups from aliphatic dicarboxylic acids such as succinic acid, dimethylmalonic acid, glutaric acid, methylsuccinic acid, adipic acid, dimethylsuccinic acid, pimellic acid, suberic acid, azelaic acid, sebacic acid, decanedicarboxylic acid or dimeric fatty acid or cycloaliphatic dicarboxylic acids such as 1,2-, 1,3-, 1,4-cyclohexanedicarboxylic acid, and aromatic carboxylic acids such as terephthalic acid, isophthalic acid, phthalic acid, naphthalene-1,2, -1,4, -1,5, -1,8 dicarboxylic acids, 5-methylisophthalic acid, tetrahydrophthalic acid and hexahydroendomethylene-tetrahydrophthalic acid, may be mentioned.

Examples of A, as optionally substituted divalent groups from aliphatic, cycloaliphatic, araliphatic or aromatic hydrocarbons which may be mentioned are the parent hydrocarbon groups from in particular aliphatic diisocyanates such as hexamethylene diisocyanate or trimethylhexamethylene diisocyanate-1,6, cycloaliphatic diisocyanates such as cyclohexane-1,4 diisocyanate, cyclopentane-1,3 diisocyanate, methylene-bis-(4,4′-cyclohexyl) diisocyanate and 1-isocyanatomethyl-5-isocyanato-1,3,3-trimethylcyclohexane and aromatic diisocyanates such as 2,4- and 2,6-toluylene diisocyanate, 3,3′-dimethyl-4,4′-diphenylmethanediisocyanate, 4,4′-diphenylmethane diisocyanate and 4,4′-diphenylether diisocyanate.

Examples of R₃, as optionally substituted alkyl groups which may be mentioned are C₁-C₁₈ alkyl groups such as methyl, ethyl, propyl, n-butyl, sec.-butyl, i-propyl, tert.-butyl, i-butyl, pentyl, i-pentyl, neopentyl, heptyl, n-hexyl, 2-ethyl-hexyl, nonyl, decyl, cetyl, dodecyl and stearyl groups and, as cycloaliphatic groups, cyclopentyl and cyclohexyl groups, optionally substituted by methyl groups. Suitable araliphatic groups are primarily the benzyl group and benzyl groups substituted by methyl and lower alkoxy groups.

Compounds of the formula (I) (polyfunctional acrylic acid derivatives or methacrylic acid derivatives) are compounds which contain ether, ester, urethane and/or urea groups. Polyethers and/or polyester-polyols are preferably reacted with acrylic acid derivatives or methacrylic acid derivatives.

Compounds of the formula (III) (monofunctional acrylates or methacrylates) are esters of acrylic acid or methacrylic acid which also contain an ester, urethane and/or urea group.

Polymers according to the invention may contain conventional additives.

Light guides produced according to the invention may contain further constituents. For example, they may contain adhesion-promoting intermediate layers. For example, they may contain protective sheathing layers, in particular those which are flexible but resistant to aqueous solutions and to mineral oils and fuels, such as e.g. thermoplastic polyurethanes and rubbers.

Preferred coatings according to the invention may contain conventional additives.

Preferred coatings according to the invention may contain, in addition to components A and B, conventional additives such as e.g. solvents which are inert towards polycarbonates, polymerisation inhibitors, antioxidants, etc.

Photoinitiators are well-known and commercially available. The following may be mentioned as photoinitiators, for example: benzoin, benzoin ether, benzyl ketals, benzophenone, thioxanthone and their derivatives e.g. benzylmethyl ketal and 2-hydroxy-2-methyl-1-phenyl-propan-1-one.

Transparent and amorphous thermoplastic polymers may be used in accordance with the invention. From among these, polycarbonates are preferred. The said transparent, amorphous, thermoplastic polymers and the preparation thereof are known to a person skilled in the art. In particular polycarbonate and the preparation thereof is known to a person skilled in the art.

Polymers which are used in the process according to the invention are those the transparency of which is sufficient for the purpose of light-guiding. These are amorphous polymers and polycondensates which may be based on one or more monomers such as e.g. esters and their copolymers or mixtures of acrylic acid and methacrylic acid like those in which C₁ alcohols to C₁₈ alcohols (optionally branched) have been used for esterification, in particular the methyl, butyl and phenyl esters. Furthermore, polystyrene and its copolymers and mixtures, hydrogenated polystyrene, cyclic polyolefins and their copolymers with alkenes, in particular ethylene and propylene are suitable, provided these polymers are transparent and polycarbonates and polyesters based on esters of terephthalic acid, esters of isophthalic acid, esters of naphthalene dicarboxylic acid and their mixtures, and the corresponding suitable diols and their mixtures which produce transparent polycondensates or polycarbonates of one or more bisphenols and their transparent blends.

In a preferred embodiment of the present invention the amorphous, transparent, thermoplastic polymer, which is in particular a polycarbonate, contains less than 80 000 particles per gram of particles insoluble in the polymer with a size of 0.3 to 10 μm. It preferably contains less than 45 000 particles/g with a size of 0.3 to 0.6 μm and less than 30 000 particles/g with a size of 0.6 to 1.0 μm and less than 3 000 particles/g with a size of 1.0 to 2.0 μm and less than 500 particles/g with a size of 2.0 to 5.0 μm and less than 200 particles/g with a size of 5.0 to 10 μm. Particularly preferably it contains less than 30 000 particles/g with a size of 0.3 to 0.6 μm and less than 20 000 particles/g with a size of 0.6 to 1.0 μm and less than 2 000 particles/g with a size of 1.0 to 2.0 μm and less than 300 particles/g with a size of 2.0 to 5.0 μm and less than 100 particles/g with a size of 5.0 to 10 μm. Very particularly preferably it contains less than 25 000 particles/g with a size of 0.3 to 0.6 μm and less than 10 000 particles/g with a size of 0.6 to 1.0 μm and less than 1 500 particles/g with a size of 1.0 to 2.0 μm and less than 50 particles/g with a size of 2.0 to 5.0 μm and less than 20 particles/g with a size of 5.0 to 10 μm. Furthermore, it is preferred that the said upper limits for the said particle contents are not exceeded either in the polymer used or in the light guide cores after processing the polymer.

According to the invention, polycarbonates made from bisphenols and their blends with polyesters of aromatic acids are also preferred.

Polycarbonates and the common methods for preparing them are described e.g. in “Chemistry and Physics of Polycarbonates” Polymer Rev. vol. 9, Interscience Publishers. They may optionally be prepared with the addition of known chain-terminators (see e.g. EP-A 0 010 602, DE-A 3 143 252), branching agents such as trisphenols and/or isatinbiscresol (phenol) (see e.g. DE-A 1 570 533, DE-A 1 595 762, DE-A 2 500 092), stabilisers such as phosphanes and/or phosphites (see e.g. EP-A 0 143 906, DE-A 21 40 207) and mould release agents (see e.g. DE-A 2 507 748, DE-A 2 729 485 and DE-A 2 064 095). Processing the polycarbonates is preferably performed in a known manner by precipitating, spray-evaporating or extruding. The relative viscosity of a 0.5% strength solution of the polycarbonate in methylene chloride at 25° C. is preferably between 1.18 and 1.32.

According to the invention, preferred polycarbonates are polycarbonates the degree of purity of which is suitable for optical applications, e.g. optical storage media and the low molecular weight of which makes them suitable for the production of compact discs, DVDs, etc. By way of example, polycarbonates with a Mw of 12 000 to 25 000, preferably 15 000 to 22 000, very particularly preferably 17 000 to 21 000 g/mol may be mentioned.

Particularly preferred polycarbonates are the homopolycarbonate based on bisphenol A, the homopolycarbonate based on 1,1-bis-(4-hydroxyphenyl)-3,3,5-trimethyl-cyclohexane, the homopolycarbonate based on one of the following bisphenols

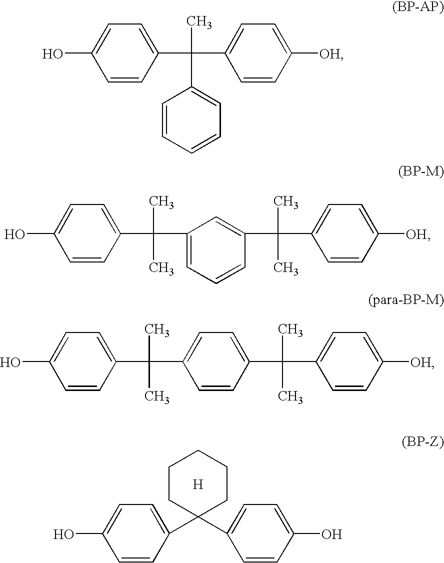

and the copolycarbonates made from combinations of the bisphenols mentioned, in particular the copolycarbonate based on the two monomers bisphenol A and 1,1-bis-(4-hydroxyphenyl)-3,3,5-trimethylcyclohexane.

The homopolycarbonate based on bisphenol A is very particularly preferred.

The polycarbonate preferably has a heavy metal content of less than 5 ppm, in particular less than 3 ppm, very particularly less then 0.5 ppm. Small concentrations of heavy metals cause a small degree of optical damping in the light guide.

The polycarbonate may be prepared by known processes, e.g. by the phase interface process from bisphenol and phosgene or by the melt transesterification process from a carbonate and bisphenol.

In a preferred embodiment according to the invention, the viscosity of the compositions polymerisable by UV irradiation which are applied to the polycarbonate fibres may be varied over wide limits by choosing the molecular weight of components A and B and/or by the ratio of components A and B and may be adjusted to the intended rates of spinning out and the spinning temperature of the polycarbonate fibres. The compositions to be used according to the invention preferably have a viscosity of 500 to 10 000 cP at 25° C. Compositions to be used according to the invention may preferably be processed at temperatures of 15 to 140° C.

In accordance with the process used, the polycarbonate core for the light guide of polycarbonate fibres may be produced first and this can be provided later with the coating materials to be applied according to the invention. However, it is more advantageous to apply the coating immediately after producing the polycarbonate fibres. The thickness of the coating to be applied according to the invention to the polycarbonate fibres is preferably less than 50 μm.

The light guides according to the invention may be processed to give single strand or multiple strand cables by encasing the light guides per se individually or by encasing several light guides made into a bundle with further polymer layers, e.g. by coextrusion. The polymer layer is then preferably a thermoplastic elastomer.

The light guides may be glued together by the coating to form a bundle or ribbons.

The diameter of the light guide is preferably between 0.05 mm and 5 mm, particularly preferably 0.1 mm to 3 mm, very particularly preferably 0.25 to 1.5 mm.

Light guides according to the invention may also be used as illuminating elements. For this purpose, the surface of the light guide is damaged at the required points. This couples up the light. Alternatively, the light may be passed to the place which is required to be illuminated. For example, fittings, for example in electronic equipment such as radios or computers, may be illuminated in this way.

Extruders which may be used in the process according to the invention are single-screw and twin-screw extruders. Twin-screw extruders are preferred, wherein those with counter-rotating screws are preferred over those with screws which rotate in the same direction. The layout of the screw may optionally contain compounding elements, but care should be taken to ensure that melting and processing of the polymer is performed under the gentlest possible conditions.

In order to achieve uniform calibration of the light guide being spun out, one or more gear pumps, with or without previous melt filtration, may be located, as a discharge unit, downstream of the extruder. Dead spaces in the passage for the melt are avoided in this way. Periodic variations in thickness may be minimised by changing the shape of the gear and the number of gears in the gear wheels of the gear pumps, and also by increasing the frequency of rotation.

Materials which are used for the surfaces of the melt-guiding parts of the apparatus which is used in the process to produce light-guides, in particular in the case of an extrusion apparatus, that is e.g. extruder, gear pumps and dies, and also connecting parts, are those which are inert towards the polymer melt, in particular a polycarbonate melt. These are in particular stainless steels, especially those with low iron contents and in particular those with inertised surfaces such as can be produced e.g. by nitriding. Other preferred materials for the melt-guiding surfaces are low-iron alloys, in particular chromium/nickel alloys such as are known under the commercial names Alloy and Hastelloy. Furthermore, ceramic materials are preferred.

Light guides such as those produced by means of such an apparatus, are preferably provided with a coating on-line. This coating is part of the optical system and has to have a lower refractive index than the light-guiding core material. Therefore, if aliphatic polymers, such as e.g. acrylates or methacrylates, are used for the light-guiding core then it is sensible to used fluorinated polymers or lacquers as the coating because the refractive index is lowered by fluorination. Conversely, it is possible, alternatively or in addition, to increase the refractive index of the polymer used as the light-guiding core by deuterating the building blocks used there.

The coating may be applied as a thermoplastic material by coextrusion or from solution from a solvent which is inert towards the core material or by lacquering and then curing the lacquer by means of heat or UV irradiation. Preferred coating compositions are UV-curing. Particularly preferred coatings have been described in the text above.

### EXAMPLES

As a measure of the suitability of a material for the surfaces of the polymer-contacting parts of the apparatus for the process according to the invention, the discoloration of the polymer was assessed when this had been in contact for a specific time as the melt with the corresponding material at a defined temperature.

The homopolycarbonate based on bisphenol A was used as the polymer.

| | Temperature | | Yellowness index |
|---|---|---|---|
| Material | in ° C. | Time in minutes | YI |
| 1.4539 | 270 | 5 | 1.6 |
| 1.4539 | 270 | 10 | 2.2 |
| 1.4539 | 400 | 120 | 260* |
| 1.4571 | 270 | 10 | 1.7 |
| 1.4571 | 270 | 30 | 2.5 |
| 1.4571 | 335 | 30 | 2.9 |
| 1.4571 | 400 | 30 | 8.2 |
| 1.4571 | 400 | 30 | 21 |
| 1.4571 | 400 | 30 | 230* |
| Alloy59 | 270 | 5 | 1.1 |
| Alloy59 | 270 | 10 | 1.1 |
| Alloy59 | 270 | 120 | 1.9 |
| Alloy59 | 400 | 5 | 1.2 |
| Alloy59 | 400 | 10 | 5.2 |
| Alloy59 | 335 | 60 | 2.2 |
| Alloy59 | 400 | 5 | 1.8 |
| Alloy59 | 400 | 10 | 2.9 |
| Hastelloy | 270 | 5 | 1.4 |
| Hastelloy | 270 | 5 | 1.6 |
| Hastelloy | 270 | 10 | 1.6 |
| Hastelloy | 270 | 10 | 1.8 |
| Hastelloy | 400 | 5 | 1.2 |
| Hastelloy | 400 | 10 | 1.4 |
| Hastelloy | 400 | 30 | 2.5 |
| Hastelloy | 400 | 120 | 23 |

* = Formation of black crusts

1. A process for producing a light guide containing a core containing an amorphous, transparent, thermoplastic polymer, wherein the polymer is processed in the melt and wherein the surfaces of the apparatus used in this process are rendered fully or partly inert at points where they come into contact with the molten polymer.

2. A process according to claim 1, wherein the surfaces are rendered fully inert at points where they come into contact with the molten polymer.

3. A process according to claim 1 or 2, wherein the molten polymer is extruded.

4. A process according to any one of claims 1 to 3, wherein the polymer is polycarbonate.

5. A process according to claim 4, wherein the polycarbonate is the homopolycarbonate based on bisphenol A.

6. A process according to any one of claims 1 to 5, wherein the surfaces are rendered inert in that the surfaces consist of materials which contain less than 70 wt. % of metallic iron.

7. A process according to any one of claims 1 to 5, wherein the surfaces are rendered inert in that the surfaces consist of a nitride layer.

8. A process according to claim 7, wherein the nitride layer consists of iron nitride.

9. A process according to claim 6, wherein the material is chosen from the group consisting of ceramic materials, chromium/nickel alloys and stainless steel with an iron content of less than 70 wt. %.
